(19) United States
(12) Patent Application Publication
(10) Pub. No.: US 2023/0289908 A1
(43) Pub. Date: Sep. 14, 2023

(54) POLICY GENERATION APPARATUS, CONTROL METHOD, AND NON-TRANSITORY COMPUTER-READABLE STORAGE MEDIUM

(71) Applicants: NEC Corporation, Tokyo (JP); NATIONAL INSTITUTE OF ADVANCED INDUSTRIAL SCIENCE AND TECHNOLOGY, Tokyo (JP)

(72) Inventor: Yasser Farouk Othman MOHAMMAD, Tokyo (JP)

(73) Assignee: NEC Corporation, Tokyo (JP)

(21) Appl. No.: 18/005,912

(22) PCT Filed: Jul. 29, 2020
(86) PCT No.: PCT/JP2020/029145

§ 371 Date: Jan. 18, 2023

(51) Int. Cl. G06Q 50/18

(52) U.S. Cl. CPC G06Q 50/188

(57) ABSTRACT

A main party (10) operates multiple main negotiators 32 through which the main party (10) negotiates with multiple partner parties (20). A policy generation apparatus (100) generates an offer sequence for each main negotiator (32). The main negotiator (32) performs the negotiations in accordance with the offer sequence. The policy generation apparatus (100) generates the offer policy so that a global utility becomes as large as possible to achieve a good result in a whole of the concurrent negotiations. The global utility represents criteria to evaluate the quality of a whole of the concurrent negotiations.

### TECHNICAL FIELD

The present disclosure generally relates to a technique to automatically negotiate with multiple parties in parallel.

### BACKGROUND ART

Negotiation is a process by which self-interested parties aim to reach an agreement. In automated negotiation, one or more of the negotiating parties automatically performs the negotiations with a computer, such as an artificially intelligent (AI) agent. Interest in automated negotiation is increasing, because of the growing use of AI to automate business operations.

There are some disclosures that relate to an automated negotiation. PTL 1 discloses a method for automated discounting and negotiation on prices with multiple customers. NPL 1 discloses a technique to enable autonomous agents to negotiate concurrently with multiple, unknown opponents.

In both PTL1 and NPL1, a utility is independently defined for each of current negotiations, e.g. each customer or each opponent. Note that the utility received by an agent represents criteria to evaluate the quality of its negotiation strategy: the larger the utility is, the higher the quality of the negotiation strategy is.

### CITATION LIST

### Patent Literature

PTL1: US patent application publication No. 2014-0279168

### Non Patent Literature

NPL1: Williams, Colin R., Valentin Robu, Enrico H. Gerding, and Nicholas R. Jennings, “Negotiating concurrently with unknown opponents in complex, real time domains”, 20th European Conference on Artificial Intelligence, August, 2012

### SUMMARY OF INVENTION

### Technical Problem

The utility of a single negotiation cannot be precisely judged independent of the outcomes of other negotiations. For example, a buyer cannot judge the utility of buying an item at a price of 10 dollars except by considering the selling price which results from a different negotiation and also other suppliers with whom it is currently in negotiation. Due to low preciseness of the utility as described above, it is difficult for the method disclosed by PTL1 or NPL1 to precisely evaluate the quality of a whole concurrent negotiations.

One of objectives of the present disclosure is to provide a technique to enable to concurrently negotiate with multiple parties precisely taking the quality of a whole of concurrent negotiations into account.

### Solution to Problem

The present disclosure provides a policy generation apparatus comprising: at least one processor and a memory storing instructions.

The at least one processor is configured to execute the instructions to: acquire an acceptance model for each of main negotiators, each of the main negotiators negotiating with different one of partner negotiators; generates an offer policy using the obtained acceptance models, the offer policy including an offer sequence for each of the main negotiators, the offer sequence for the main negotiator including a sequence of offers which the corresponding main negotiator provides to the corresponding partner negotiator; and output the generated offer policy.

The generation of the offer policy includes to initialize the offer policy and perform a modification of the offer policy.

The modification of the offer policy includes to perform, for each of the main negotiators: computing a marginal distribution of a weighed global utility for that main negotiator, a distribution of the weighed global utility associating a set of outcomes each of which is obtained by the respective main negotiators with the weighed global utility given the set of the outcomes, the weighed global utility given the set of the outcomes being a global utility given the set of the outcomes weighed by probability of occurrence of the set of the outcomes that is computed using the acceptance models, the global utility representing criteria of quality of a whole of the negotiations between the main negotiators and the partner negotiators, the marginal distribution of the weighed global utility for that main negotiator being computed by marginalizing out the outcomes other than the outcome obtained by that main negotiator from the distribution of the weighed global utility; and replacing the offer sequence of that main negotiator in the current offer policy by the offer sequence of that main negotiator which maximizes an expected value of the global utility, the expected value of the global utility given the offer sequence being computed by summing the weighed global utilities each of which is associated with one of the offers in that offer sequence by the marginal distribution of the weighed global utility for that main negotiator.

The present disclosure further provides a control method performed by a computer. The control method comprising: acquiring an acceptance model for each of main negotiators, each of the main negotiators negotiating with different one of partner negotiators; generating an offer policy using the obtained acceptance models, the offer policy including an offer sequence for each of the main negotiators, the offer sequence for the main negotiator including a sequence of offers which the corresponding main negotiator provides to the corresponding partner negotiator; and output the generated offer policy.

The generation of the offer policy includes to initialize the offer policy and perform a modification of the offer policy.

The modification of the offer policy includes to perform, for each of the main negotiators: computing a marginal distribution of a weighed global utility for that main negotiator, a distribution of the weighed global utility associating a set of outcomes each of which is obtained by the respective main negotiators with the weighed global utility given the set of the outcomes, the weighed global utility given the set of the outcomes being a global utility given the set of the outcomes weighed by probability of occurrence of the set of the outcomes that is computed using the acceptance models, the global utility representing criteria of quality of a whole of the negotiations between the main negotiators and the partner negotiators, the marginal distribution of the weighed global utility for that main negotiator being computed by marginalizing out the outcomes other than the outcome obtained by that main negotiator from the distribution of the weighed global utility; and replacing the offer sequence of that main negotiator in the current offer policy by the offer sequence of that main negotiator which maximizes an expected value of the global utility, the expected value of the global utility given the offer sequence being computed by summing the weighed global utilities each of which is associated with one of the offers in that offer sequence by the marginal distribution of the weighed global utility for that main negotiator.

The present disclosure further provides a non-transitory computer readable storage medium storing a program. The program that causes a computer to execute the control method of the present disclosure.

### Advantageous Effects of Invention

According to the present disclosure, it is possible to provide a technique to enable to negotiate with multiple parties in parallel precisely taking the quality of a whole of concurrent negotiations into account.

### BRIEF DESCRIPTION OF DRAWINGS

FIG. 1 illustrates negotiations between a main party and multiple partner parties.

FIG. 2 is a block diagram illustrating an example of the functional configuration of the policy generation apparatus.

FIG. 3 illustrates an example of the acceptance models stored in a storage device in a table format.

FIG. 4 is a block diagram illustrating an example of the hardware configuration of a computer realizing the policy generation apparatus.

FIG. 5 is a flowchart illustrating an example flow of processes that the policy generation apparatus of the 1st example embodiment performs.

FIG. 6 is a flowchart illustrating an example flow of processes to generate the offer policy.

FIG. 7 is a flowchart illustrating an example flow of processes to obtain an approximation of the expected utility for the main negotiator 32-e.

FIG. 8 shows an example of a pseudo-code of the GCA algorithm.

FIG. 9 shows an example of a pseudo-code of the QGCA algorithm.

FIG. 10 shows a flowchart illustrating an example flow of processes that the policy generation apparatus of the second example embodiment performs.

FIG. 11 shows a block diagram illustrating an example of the functional configuration of the policy generation apparatus of the 2nd example embodiment.

### DESCRIPTION OF EMBODIMENTS

Example embodiments according to the present disclosure will be described hereinafter with reference to the drawings. The same numeral signs are assigned to the same elements throughout the drawings, and redundant explanations are omitted as necessary.

### First Example Embodiment

<Environment>

In this embodiment, it is supposed that there are a main party and multiple partner parties. The main party negotiates with each of the respective multiple partner parties for various purposes. For example, the main party is a fast food company whereas the partner parties are seller that sells raw materials to the fast food company. The fast food company may negotiate with multiple sellers in order to obtain raw materials with higher quality at lower cost. As the result of the negotiations, the fast food company obtains (i.e. purchases) the raw materials from the sellers with which the negotiation reaches an agreement.

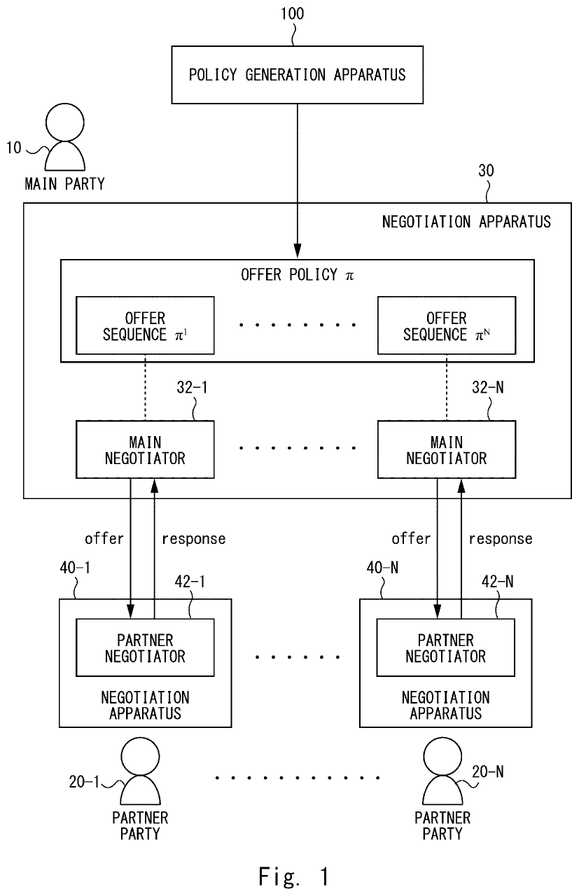

The main party negotiate with the partner parties using one or more computers. FIG. 1 illustrates negotiations between a main party and multiple partner parties. In FIG. 1, the main party 10 operates a negotiation apparatus 30, whereas each of the respective partner parties 20 operates a negotiation apparatus 40. In addition, the negotiation apparatus 30 runs multiple main negotiators 32, whereas the negotiation apparatus 40 a partner negotiator 42. When the main party 10 negotiates with the partner party 20-1, the main negotiators 32-1 running on the negotiation apparatus 30 performs a negotiation with the partner negotiator 42-1 running on the negotiation apparatus 40-1 that is operated by the partner party 20-1. Note that the main negotiator 32 may negotiate with one or more of the partner negotiators 42. The main negotiator 32 may be, for example, a process or a thread running on the negotiation apparatus 30. Similarly, the partner negotiator 42 is, for example, a process or a thread running on the negotiation apparatus 40.

Note that the main party is not necessarily to be buyers, but be sellers. In this case, for example, the main party negotiates with the multiple partner parties to sell their products to one or more of the partner parties.

Note that, there may be multiple negotiation apparatuses 30 each of which runs one or more the main negotiators 32. In addition, the negotiation apparatus 40 may run multiple partner negotiators 42. In this case, the corresponding partner party may perform multiple negotiation with the main party. Suppose that a partner party wants to sell multiple types of materials to the main party. In this case, the partner party may perform a negotiation with the main party for each type of material.

In this embodiment, the main negotiator 32 performs a negotiation in accordance with an offer sequence. The offer sequence describes a sequence of offers that the main negotiator 32 provides to the corresponding partner negotiator 42 in turn. The offer represents an outcome that the main negotiator 32 desires to obtain. Hereinafter, offer and outcome are used interchangeably. Suppose that the main negotiator 32 negotiates with the partner negotiator 42 to buy raw materials X1. In this case, an offer may represent a pair of the quantity and the cost: the quantity describes how many materials the main party wants to purchase from the partner party; and the cost describes how much money the main party pay for the material to the partner party. Given that the main party can provides three offers to the partner party in total, the offer sequence describes a sequence of three pairs of the quantity and the cost, e.g. {(quantity=q1, cost=c1), (quantity=q2, cost=c2), (quantity=q3, cost=c3)}.

Hereinafter, the offer sequence provided to the main negotiator 32-e is denoted by π\hat{ }e, where e represents an index of the main negotiator 32. The i-th offer in the offer sequence ee is denoted by π\hat{ }e[i]. The total number of the main negotiators 32 (i.e. the total number of concurrent negotiations) is denoted by N. The total number of the offers that each main negotiator 32 can provide is denoted by T.

Each main negotiator 32 performs a negotiation in accordance with the corresponding offer sequence in a round robin fashion. This means that, in the i-th round of the negotiations, the offers provided by the main negotiators 32-1 to 32-N are π\hat{ }1[i] to π\hat{ }N[i], respectively. Each main negotiator 32 negotiates with the corresponding partner negotiator 42 until its offer is accepted. An example of an algorithm for such the way of negotiations is Stacked Alternating Offers Protocol (SAOP).

<Overview of Policy Generation Apparatus 100>

A policy generation apparatus 100 of the 1st example embodiment generates the offer sequence for each main negotiator 32 (See FIG. 1). Hereinafter, the set of the offer sequences provided to the negotiators 30 is described as an offer policy π. Thus, the offer policy π includes π\hat{ }1, π\hat{ }2, . . . , π\hat{ }N.

The policy generation apparatus 100 generates the offer policy so that the main party can achieve a good result in the negotiations with the partner parties. To do so, there needs criteria to evaluate the quality of a whole of concurrent negotiations between the main negotiators 32 and the partner negotiators 42. In this disclosure, this criterion is called “global utility”. The policy generation apparatus 100 uses a global utility function u( ) to evaluate the global utility of the negotiations. Specifically, the global utility function u( ) takes the set of outcomes obtained from each of the respective main negotiators 32 as inputs, and outputs a real value representing the global utility of a whole of the negotiations given those outcomes. The global utility function is predefined in advance based on, for example, business requirements of the main party, and stored in a storage device to which the policy generation apparatus 100 has access.

As described later in detail, the policy generation apparatus 100 generates the offer policy so that the global utility becomes as large as possible. By doing so, the policy generation apparatus 100 can generate the offer policy precisely taking a whole of the concurrent negotiations between the main negotiators 32 and the partner negotiators 42 into account. It enables the main party to concurrently perform globally effective negotiations with the multiple partner parties.

### Example of Functional Configuration

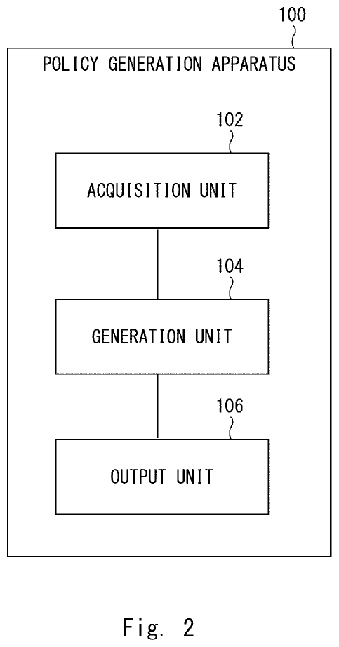

FIG. 2 shows a block diagram illustrating an example of functional configuration of the policy generation apparatus 100 of the 1st example embodiment. The policy generation apparatus 100 includes an acquisition unit 102, a generation unit 104, and output unit 106. The acquisition unit 102 acquires an acceptance model (described later in detail) for each partner negotiator 42. The generation unit 104 generates the offer policy using the acceptance models that the acquisition unit 102 acquires. The output unit 106 outputs the offer policy so that the main negotiators 32 can perform the negotiations in accordance with the offer policy.

<<Acceptance Model>>

The acceptance model for the main negotiator 32-e represents probability of acceptance of all possible outcomes of the negotiation performed by the main negotiator 32-e. Hereinafter, the acceptance model for the main negotiator 32-e is denoted by a\hat{ }e. Specifically, a\hat{ }e(w,i) represents the probability (a value between zero to one) of that the outcome w is accepted at the i-th offer from the main negotiator 32-e.

From the viewpoint of partner negotiator 42, the acceptance model a\hat{ }e represents the probability of that the partner negotiator 42-e accepts the offer from the main negotiator 32-e. Specifically, a\hat{ }e(w,i) represents the probability of that the partner negotiator 42-e accepts the offer corresponding to the outcome w at the i-th round. Note that an offer corresponds to an outcome means that the offer results in the outcome.

The acceptance model is prepared in advance for each possible subject of the negotiation. The subject of the negotiation may be the partner party with which the main party negotiates, or may be a pair of the partner party and a product for which the partner party negotiates with the main party. For example, in the case where the main party negotiates with a partner party P1 to purchase the raw materials X1, the subject of this negotiation may be denoted by (P1, X1).

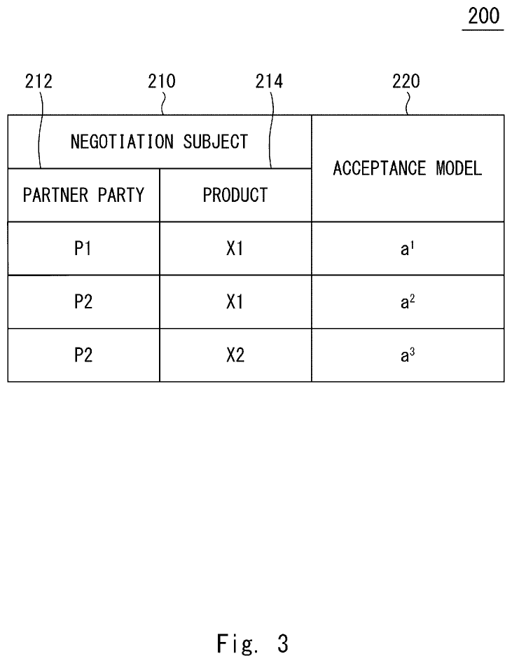

FIG. 3 illustrates an example of the acceptance models stored in a storage device in a table format. A table 200 in FIG. 3 includes an association between a negotiation subject 210 and an acceptance model 220. The negotiation subject includes a partner party 212 and a product 214.

The acceptance model is generated based on the knowledge that the main party has as to the corresponding partner party. In other words, the acceptance model for a certain partner party is generated so that it summarizes the knowledge as to that partner party. For example, the acceptance model for a certain partner party is generated based on the history of the past negotiations between the main party and that partner party. By doing so, it is possible to generate the acceptance model for each partner party without knowing concrete criteria (e.g. a utility function or a negotiation strategy) based on which the partner party negotiates with the main party.

There may be various types of acceptance model, such as a static acceptance model, monotonically increasing acceptance model, a general acceptance mode. The static acceptance model is an acceptance model whose output does not change over time. The monotonically increasing acceptance model is an acceptance model whose output only increases over time. The general acceptance model is an acceptance model whose output may increase or decrease over time.

### Example of Hardware Configuration of Policy Generation Apparatus 100

The policy generation apparatus 100 may be realized by one or more computers. Each of the one or more computers may be a special-purpose computer manufactured for implementing the policy generation apparatus 100, or may be a general-purpose computer like a personal computer (PC), a server machine, or a mobile device. The policy generation apparatus 100 may be realized by installing an application in the computer. The application is implemented with a computer program that causes the computer to function as the policy generation apparatus 100. In other words, the computer program is an implementation of the functional units of the policy generation apparatus 100.

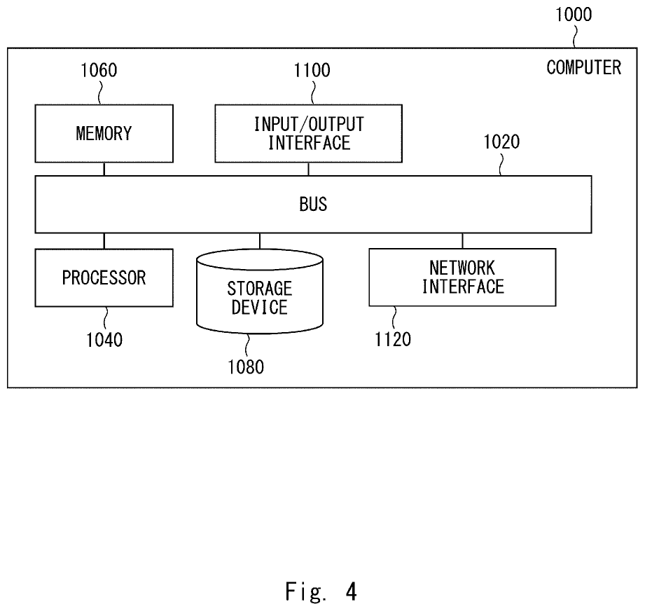

FIG. 4 shows a block diagram illustrating an example of the hardware configuration of a computer 1000 realizing the policy generation apparatus 100. In FIG. 4, the computer 1000 includes a bus 1020, a processor 1040, a memory 1060, a storage device 1080, an input/output interface 1100, and a network interface 1120.

The bus 1020 is a data transmission channel in order for the processor 1040, the memory 1060, the storage device 1080, and the input/output interface 1100, and the network interface 1120 to mutually transmit and receive data. The processor 1040 is a processer, such as a CPU (Central Processing Unit), GPU (Graphics Processing Unit), or FPGA (Field-Programmable Gate Array). The memory 1060 is a primary memory component, such as a RAM (Random Access Memory) or a ROM (Read Only Memory). The storage device 1080 is a secondary memory component, such as a hard disk, an SSD (Solid State Drive), or a memory card. The input/output interface 1100 is an interface between the computer 1000 and peripheral devices, such as a keyboard, mouse, or display device. The network interface 1120 is an interface between the computer 1000 and a network. The network may be a LAN (Local Area Network) or a WAN (Wide Area Network).

The storage device 1080 may store the computer program mentioned above. The CPU 1040 executes the computer program to realize each functional unit of the policy generation apparatus 100.

The hardware configuration of the computer 1000 is not limited to the configuration shown in FIG. 4. For example, as mentioned-above, the policy generation apparatus 100 may be realized by plural computers. In this case, those computers may be connected with each other through the network.

<Flow of Processes>

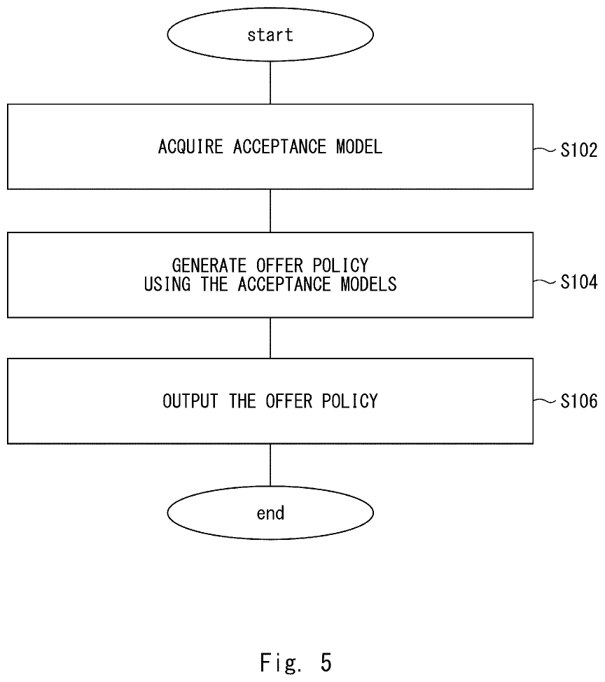

FIG. 5 shows a flowchart illustrating an example flow of processes that the policy generation apparatus 100 of the 1st example embodiment performs. The acquisition unit 102 acquires the acceptance model for each partner negotiator 42 (S102). The generation unit 104 generates the offer policy using the acceptance models (S104). The output out 106 outputs the offer policy (S106).

Hereinafter, each of the above steps are explained in detail.

<Acquisition of Acceptance Model: S102>

The acquisition unit 102 acquires the acceptance models for each main negotiator 32 (S102). In order to obtain the acceptance models to be used, it is necessary to know the subjects of the negotiations performed by the negotiation apparatus 30, e.g. pairs of the partner party 20 and the product (See FIG. 3). For example, the acquisition unit 102 acquires a list of the subjects of the negotiations, and acquires the acceptance model for each of the respective subjects from the table depicted in FIG. 3.

<Generation of Offer Policy: S104>

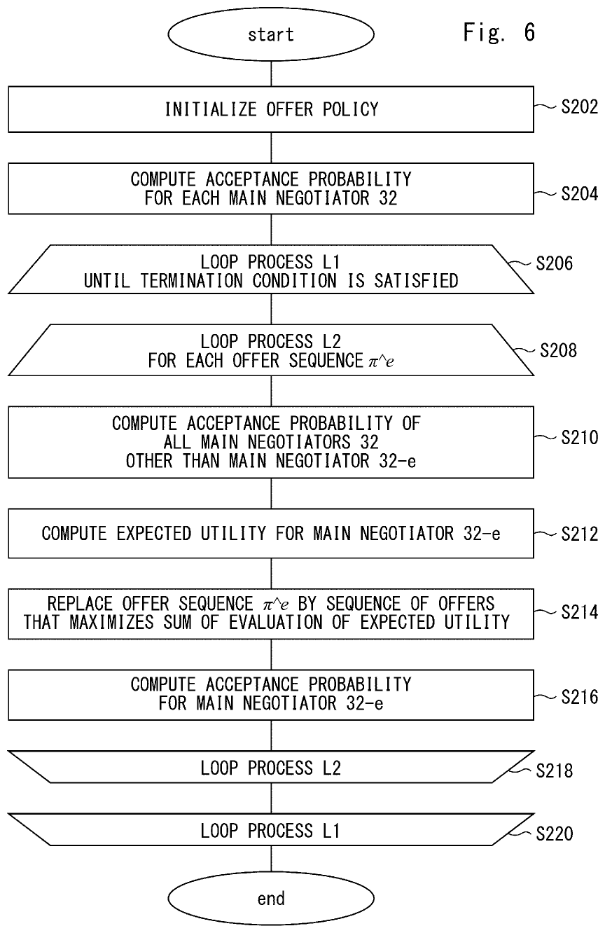

The generation unit 104 generates the offer policy using the acceptance models (S104). FIG. 6 shows a flowchart illustrating an example flow of processes to generate the offer policy. The generation unit 104 initializes the offer policy (S202). There may are various ways to initialize the offer policy. For example, the generation unit 104 may compute the offer policy with which the global utility is maximum without taking the acceptance models into account, and use this offer policy as the initial one. In another example, the generation unit 104 initializes the offer policy at random.

Since the probability of acceptance is not taken into consideration in the above ways, it is highly possible that some of the negotiations in accordance with the initial offer policy fail to reach an agreement. In other words, the initial offer policy may include an offer sequence neither of whose offers is accepted. Thus, the generation unit 104 modify the offer policy taking the acceptance model into consideration so that the negotiations in accordance with the offer policy become capable of reaching an agreement.

The generation unit 104 computes an acceptance probability for each main negotiator 32 given the current offer sequence (S204). The acceptance probability may be obtained by evaluating the following equation:

$$\begin{matrix}Equation 1 & \\ {p}^{k} ( {ω}^{k} \vert {π}^{k} ) = \{ \begin{matrix}{a}^{k} ( {ω}^{k} , j ) {\prod }_{n = 1}^{j - 1} \{ 1 - {a}^{k} ( {π}_{n}^{k} , n ) \} & {ω}^{k} ∈ {π}^{k} \\ 0 & {ω}^{k} ∉ {π}^{k}\end{matrix} & ( 1 )\end{matrix}$$

where p^{k}(ω^{k}|π^{k}) represents the acceptance probability for the main negotiator 32-k, and π^{k} represents the offer sequence for the main negotiator 32-k.

As shown in the above equation, the acceptance probability for the main negotiator 32-k is computed based on the acceptance model for it. Note that when the main negotiator 32-k negotiates with multiple partner negotiators 42, the generation unit 104 uses a product of the acceptance models corresponding to that multiple partner negotiators 42 as the acceptance model for the main negotiator 32-k. Suppose that the main negotiator 32-k negotiate with the partner negotiators 42-x, 42-y, and 42-z. In this case, the acquisition unit 102 acquires three acceptance models a_x, a_y and a_z that correspond to the partner negotiators 42-x, 42-y, and 42-z, respectively. Then, the generation unit 104 uses the product a_x*a_y*a_z as the acceptance model a\hat{ }k for the main negotiator 32-k.

Since the acceptance probability described above is a conditional probability given the current offer sequence, the change in the offer sequence causes the change in the acceptance probability. In addition, since the offer sequence is modified based on the acceptance probability as described later, the change in the acceptance probability also causes the change in the offer sequence. Thus, the generation unit 104 repeatedly performs the modification of the offer policy until the offer policy converges to some extent as follows.

Step S206 to S218 constitute a loop process L1 that includes a sequence of processes to modify a whole of the offer policy. The generation unit 104 repeats the loop process L1 until the offer policy converges to some extent. Specifically, the generation unit 104 repeats the loop process L1 until a predefined termination condition is satisfied. The termination condition may be, for example, that “the offer policy is not changed in the previous loop”, “a predetermined time has passed (e.g. the loop process L1 has been performed the predetermined number of times)”, or “an expected utility is not improved more than a predefined constant”.

At Step S206, the generation unit 104 determines whether or not the predetermined condition is satisfied. If the termination condition is satisfied, the modification of the offer policy ends and the S220 is performed next (described later in detail). On the other hand, if the termination condition is not satisfied, Step S208 is performed (the modification of the offer policy continues).

Step S208 to S216 constitute a loop process L2 that includes a sequence of processes to modify one of the offer sequences in the offer policy. At Step S208, the generation unit 104 determines whether all of the offer sequences have been modified. If it is determined that all of the offer sequences have been modified, the loop process L2 ends, and Step S218 will be performed next. On the other hand, if it is determined that not all of the offer sequences have been modified, the generation unit 104 choose one of the offer sequences that are not modified yet as the offer sequence to be modified this iteration of the loop process L2. The index of offer sequence chosen here is denoted by e. In other words, the offer sequence π\hat{ }e for the main negotiator 32-e will be modified this iteration.

There may be various ways to choose the offer sequence to be modified at Step S208. For example, the generation unit 104 may chose the offer sequence in the order of the index of the offer sequence: i.e. the offer sequences π\hat{ }1 to π\hat{ }N are chosen in this order. In another example, the generation unit 104 may chose the offer sequence at random.

The generation unit 104 computes the acceptance probability of all of the main negotiators 32 other than the main negotiator 32-e (S210). This computation may be realized by evaluating the following equation:

Equation 2

p^{-e}((ω^{-e}|π^{-e})=Π_{ω}_{^{τ}}_{∈Ω}_{^{−e}}p^{τ}(ω^{τ},π^{τ}) (2)
where p^{-e} (ω^{-e}|π^{-e}) represents the acceptance probability of all of the main negotiators 32 other than the main negotiator 32-e,
ω^{-e} represents all of the possible outcomes other than ω^{e}, and π^{-e} represents all of the offer sequences in the offer policy π other than π^{e}.

The generation unit 104 computes a marginal distribution of weighed global utility (hereinafter, an expected utility) for the main negotiator 32-e (S212). Note that the weighed global utility given the set of the outcomes is the global utility given that set of the outcomes weighed by the possibility of occurrence of that set of the outcomes. The expected utility for the main negotiator 32-e can be computed by marginalizing out w′-e from the distribution of the weighed global utility. For example, the expected utility for the main negotiator 32-e may be computed by evaluating the following equation:

Equation 3

EU^{e}(ω^{e}|π^{e})=∫_{Ω}_{^{−e}}p^{-e}(ω^{-e}|π^{-e})u(ω)dω^{-e} (3)
where EU^{e}(ω^{e}|π^{e}) represents the expected utility for the main negotiator 32-c, and u(ω) represents the global utility function.

Concrete ways of computing Equation (3) will be described later.

The generation unit 104 modifies the offer sequence π\hat{ }e using the expected utility (S214). This modification may be performed as follows:

$$\begin{matrix}Equation 4 & \\ {π}^{e *} \vert {π}^{- e} ← {arg max}_{{π}^{e}} {\int }_{{Ω}^{e}} {p}^{e} ( {ω}^{e} \vert {π}^{e} ) E {U}^{e} d {ω}^{e} & ( 4 )\end{matrix}$$

where π^{e*} represents a modified version of the offer sequence for the main negotiator 32-e.

The above equation means that the generation unit 104 finds out a sequence of offers from the main negotiator 32-e that maximizes the sum of the evaluation of the expected utility for the main negotiator 32-e, and replacing the offer sequence for the main negotiator 32-e in the current offer policy 7E by the sequence of offers that has been found out. Concrete ways of finding out such the sequence of offers will be described later.

The generation unit 104 reevaluates Equation (1) to compute the acceptance probability for the main negotiator 32-e given the modified offer policy (S216). It is because, as described above, the change in the offer policy cause the change in the acceptance probability. Note that, the generation unit 104 does not need to perform this computation if there is no change in the offer policy at Step S214.

Step S218 is the end of the loop process L2. Thus, the generation unit 104 performs S208 (the first step of the loop process L2) next. As described above, the loop process L2 continues until it has been performed for all of the main negotiators 32.

Step S220 is the end of the loop process L1. Thus, the generation unit 104 performs S204 (the first step of the loop process L1) next. As described above, the loop process L1 continues until the predetermined termination condition becomes satisfied.

<Concrete Ways of Computing Expected Utility: S212>

At Step S212, the generation unit 104 computes the expected utility for the main negotiator 32-e. To do so, the generation unit 104 may evaluate Equation (3), or may compute an approximate solution of Equation (3) instead of evaluating it. In the former case, the generation unit 104 computes the global utility for each of all of the possible sets of outcomes. Then, the generation unit 104 computes the expected utility for each of the possible outcomes of the main negotiator 32-e by marginalizing out the outcomes of the main negotiators 32 other than the main negotiator 32-e from the distribution of the weighed global utility. The generation unit 104 generates the expected utility for the main negotiator 32-e that associates each outcome ω\hat{ }e with the weighed global utility under that outcome.

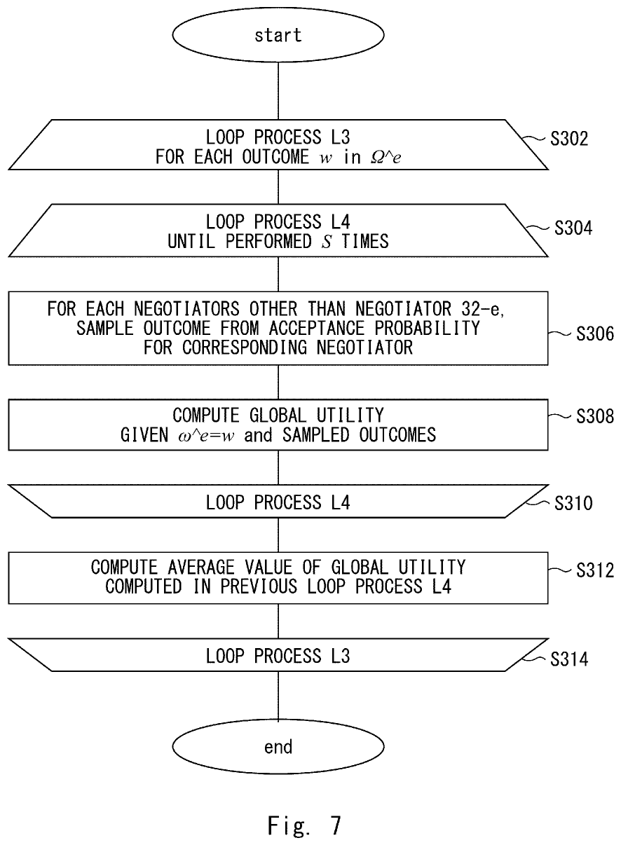

On the other hand, an approximate solution of Equation (3) can be, for example, computed as follows. FIG. 7 shows a flowchart illustrating an example flow of processes to compute an approximation of the expected utility for the main negotiator 32-e. This flow of processes is an example of a concrete implementation of the step S212 of FIG. 6.

Steps S302 to S314 constitute a loop process L3 in which the weighed global utility is computed for each of the possible outcomes ω\hat{ }e. Hereinafter, a set of all of the possible outcomes resulting from the negotiation performed by the main negotiator 32-e is denoted by Ω\hat{ }e. At the step S302, the generation unit 104 determines whether or not the loop process L3 has been performed for all of the outcomes in Ω\hat{ }e. If it is determined that the loop process L3 has been performed for all of the outcomes in Ω\hat{ }e, the generation unit 104 performs S316 next. On the other hand, if it is determined that there are one or more outcomes in Ω\hat{ }e for which the loop process L3 is not performed yet, the generation unit 104 extracts one of those outcomes from Ω\hat{ }e, and performs Step S304. Note that the outcome extracted from Ω\hat{ }e here is denoted by w, i.e. ω\hat{ }e=w.

Steps S304 to S310 constitute a loop process L4 in which the expected utility for the main negotiator 32-e given the outcome ω\hat{ }e=w is computed. The loop process L4 is repeated a predetermined number (denoted by S) of times. At Step S304, the generation unit 104 determines whether or not the loop process L4 has been performed S times. If the loop process L4 has been performed S times, the generation unit 104 performs S312 next. If the loop process L4 has not been performed S yes, the generation unit 104 performs S306 next.

For each of the main negotiators 32 other than the main negotiator 32-e, the generation unit 104 samples an outcome from the acceptance probability for the corresponding main negotiator 32 (S306). In other words, the generation unit 104 selects an outcome at random from the acceptance probability for the main negotiator 32-i to sample ω\hat{ }i, for each i being within 1 to N and other than e.

The generation unit 104 evaluates the global utility function u(ω\hat{ } 1, . . . , ω\hat{ }N) given ω\hat{ }e=w and the other outcomes being sampled at S306, thereby computing the global utility given those outcomes (S308).

Step S310 is the end of the loop process L4. Thus, the generation unit 104 performs Step S304 (the first step of the loop process L4) next.

At Step S312, the generation unit 104 computes an average value of the global utilities that are obtained in the previous loop process L4 as an approximate solution of EU\hat{ }e(ω\hat{ }e=w|π\hat{ }e) as follows:

$$\begin{matrix}Equation 5 & \\ E {U}^{e} ( {ω}^{e} = w \vert {π}^{e} ) = \frac{1}{S} {\sum }_{1 \leq r \leq S} u ( {ω}_{r}^{1} , … , {ω}_{r}^{N} ) & ( 5 )\end{matrix}$$

where ωᵣ^{e}=w∀r, and
wᵣⁱ represents the outcome sampled for the main negotiator 32-i at the r-th iteration of the loop process L4.

Step S314 is the end of the loop process L3. Thus, the generation unit 104 performs S302 (the first step of the loop process L3) next.

When finishing all of the processes in FIG. 7, the generation unit 104 has obtained the average value of the global utility for each possible outcome ω\hat{ }e. This means that the generation unit 104 has obtained an approximate evaluation of EU\hat{ }e(ω\hat{ }e|π\hat{ }e) for each possible outcome ω\hat{ }e. Thus, the generation unit 104 can evaluate the integral in Equation (4) using the set of the average values of the global utility mentioned above as EU\hat{ }e(ω\hat{ }e|π\hat{ }e).

With the sampling method mentioned above, the policy generation apparatus 100 can obtain the expected utility for the main negotiator 32-e more quickly than the case where the generation unit 104 evaluates Equation (3) as it is.

Note that, it is preferable that the value of S, the number of iterations of the loop process L4, is large enough so that the average value of the expected utilities obtained through the sampling become close to the true expected utility. For example, in order to guarantee that the approximation of the expected utility is within c from the true expected utility with confidence c, the value greater than −ln(1-c)/2ε\hat{ }2 is applied to S. Note that, ε is a small positive real number that represents the acceptable deviation from the true expected utility.

<Concrete Ways of Determining New Offer Sequence: S214>

As described above, at Step S212, the generation unit 104 finds out a sequence of offers from the main negotiator 32-e that maximizes the sum of the evaluation of the expected utility for the main negotiator 32-e. There are various concrete ways do so. For example, the generation unit 104 finds out such the sequence offers in a brute force fashion. Specifically, for each possible combinations of the outcomes ω\hat{ }e, the generation unit 104 evaluates the integral in Equation (4), and compares the results of evaluations.

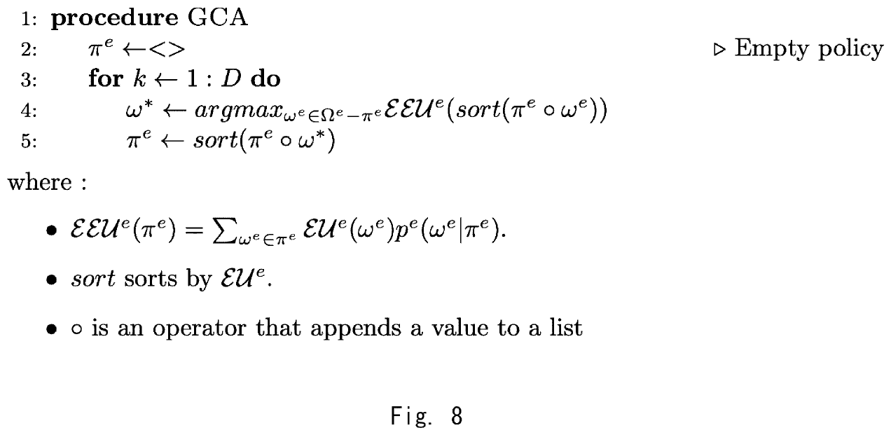

In another example, the generation unit 104 may perform GCA (Greedy Concession Algorithm) algorithm to finds out a sequence of offers from the main negotiator 32-e that maximizes the sum of the evaluation of the expected utility for the main negotiator 32-e. FIG. 8 shows an example of a pseudo-code of the GCA algorithm.

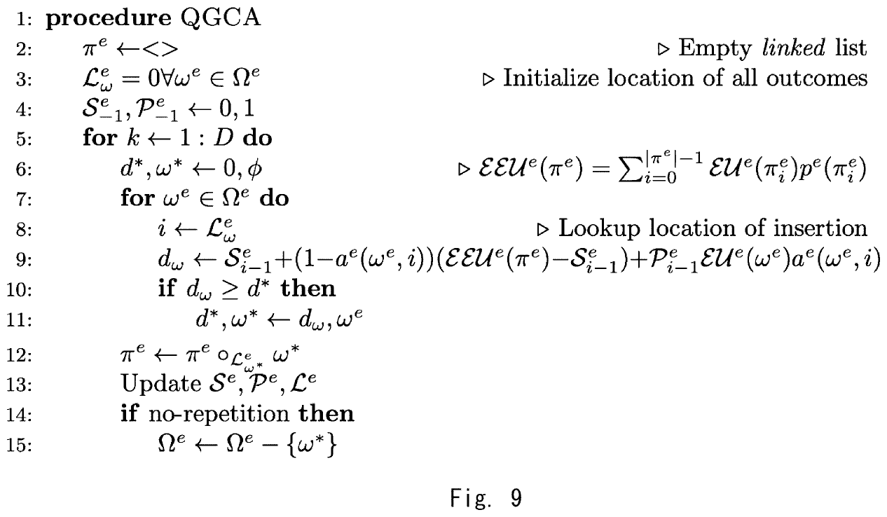

In another example, the generation unit 104 may perform an improved version of GCA algorithm. Hereinafter, this algorithm is called QGCA (Quick GCA). FIG. 9 shows an example of a pseudo-code of the QGCA algorithm. Lines 2 to 4 are processes for initialization. The goal of the QGCA algorithm is to find an offer sequence that has the maximum expected utility given the utility function EU\hat{ }e and acceptance model a\hat{ }e. The main theoretical idea behind the algorithm is the following: outcomes with higher utility value should appear first in the offer sequence. This is guaranteed to be correct in the optimal offer sequence for static acceptance models but is not guaranteed otherwise (that is why the algorithm becomes only a heuristic for optimal offer sequence for general acceptance models). The algorithm includes two parts: initialization (Lines 2-4); and a loop that greedily creates a longer offer sequence until the required length D is reached. (Lines 5-15).

In Line 2, the generation unit 104 initializes an empty list (π\hat{ }e) that will contain the optimal offer sequence by the end of the algorithm.

In Line 3, the generation unit 104 creates a list (L) that defines the location at which each outcome should be inserted if it is to be included in the offer sequence. For an offer sequence of length one we know that whatever was the outcome it will be at index zero so we initialize this list to all zeros. The index of the list L is the outcome order in some predefined ordering of all outcomes (the exact order does not have any effect on the algorithm).

In Line 4, the generation unit 104 initializes the cumulative sum (S_−1) to zero and the cumulative product (P_−1) to one. These two lists will be calculated in Line 13 using the following equations.

$$\begin{matrix}Equation 6 & \\ {S}_{í}^{e} = {{\sum }^{\vert {π}^{e} \vert - 1}}_{i = 0} {EU}^{e} ( {π}_{i}^{e} ) a ( {π}_{i}^{e} , i ) {P}_{í}^{e} & ( 6 )\end{matrix}$$

$$\begin{matrix}Equation 7 & \\ {P}_{í}^{e} = {{\prod }^{i - 1}}_{j = 0} \{ 1 - a ( {π}_{j} , j ) \} & ( 7 )\end{matrix}$$

Lines 6 to 11 are to find an outcome to be added to the existing offer sequence (remember that in the first step this offer sequence is empty).

In Line 8, the generation unit 104 gets the location to insert that outcome from the list L and set it to a variable i because outcomes with higher utility appear first in the offer sequence.

In Line 9, the generation unit 104 calculates the new expected utility (EU) after this insertion using a closed form equation. This equation uses S\hat{ }e, P\hat{ }e and the value of EU before adding this outcome and can be proven to be correct:

Equation 8

EU(π^{e}○ω^{e})=Sᵢ₋₁^{e}+(1−a^{e}(ω^{e},i))(EEU^{e}(π^{e})−Sᵢ₋₁^{e})+Pᵢ₋₁^{e}EU^{e}(ω^{e})a^{e}(ω^{e},i) (8)
where πₒ_{ₖ}ω is the offer sequence that results from adding ω at location k and i=L_{ω}^{e}.

Note that the generation unit 104 need only consider adding outcome w in one location and not trying every possible location, since it is known that all outcomes with higher utility must come before it and all ones with lower utility must come after it and the offer sequence is already sorted by utility value.

Lines 10 to 11 are to keep track the outcome that leads to the maximum increase in EU\hat{ }e (call this outcome ω\hat{ }*).

Once the best outcome to be added to the offer sequence is known from the previous steps (ω\hat{ }*), the generation unit 104 simply inserts it into the offer sequence (Line 12) and update the lists S\hat{ }e, P\hat{ }e, and L\hat{ }e to reflect the new offer sequence. As described above, S\hat{ }e and P\hat{ }e are updated using Equation (6) and (7) respectively. L\hat{ }e is updated by increasing L\hat{ }e_ω by one for all outcomes ω\hat{ }e with a utility less than the utility of ω\hat{ }* and keeping the reset of the L\hat{ }e without change.

In the case where the negotiation protocol does not allow a repetition of the offers same as each other, the just-added outcome (w\hat{ }v*) has to be removed from the candidates of the outcomes (i.e. S\hat{ }e) for future addition to the offer sequence. Thus, if the repetition is not allowed (“no-repetition” in Line 14), the generation unit 104 removes ω\hat{ }* from Ω\hat{ }e.

Note that, QGCA and GCA give exactly the same policies, but the complexity of QGCA is O(DK) whereas that of GCA is O(DK\hat{ }2) where D is the length of the offer sequence (policy) and K is the number of different outcomes per negotiation thread. Thus, for an outcomes space of only a thousand outcomes, QGCA is a thousand times faster than GCA.

<Output of Offer Policy: S106>

The output unit 106 outputs the offer policy generated by the generation unit 104 so that each main negotiator 32 can negotiate with the corresponding partner negotiator 42 in accordance with the generated offer policy. There are various ways to output the offer policy. For example, the output unit 106 sends the offer policy to the negotiation apparatus 30. The negotiation apparatus 30 puts the received offer policy into a storage device to which each main negotiator 32 has access. Each main negotiator 32 extracts the offer sequence to be used from the storage device, e.g. the main negotiator 32-e extracts the offer sequence π\hat{ }e from the storage device. In another example, the output unit 106 may put the offer policy into a storage device to which the negotiation apparatus 30 has access, such as an NAS (network attached storage) belonging to the same network as the negotiation apparatus 30.

### Second Example Embodiment 2

In the first example embodiment, the acceptance models are assumed not to be changed during the negotiations. However, in reality, there may be cases where the acceptance models change during the negotiations. In this case, it is preferable to handle the change of the acceptance models to achieve a better result of the negotiations, i.e. higher global utility.

In this embodiment, the policy generation apparatus 100 handles the change of the acceptance models. Specifically, the policy generation apparatus 100 detects that at least one of the acceptance models have changed, and updates the offer policy based on the changed acceptance models.

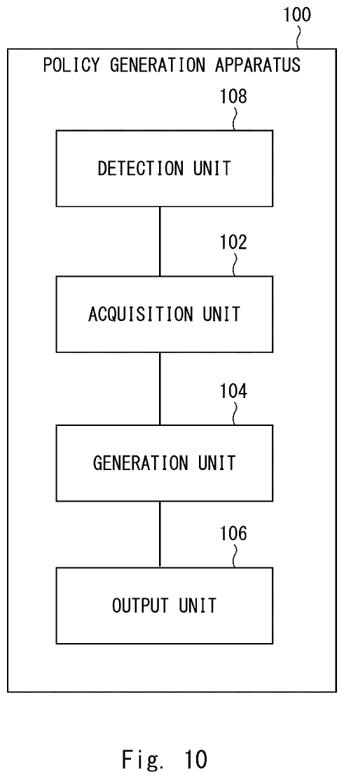

FIG. 10 shows a flowchart illustrating a basic flow of processes in the second example embodiment. This flowchart shows that, after each round of the negotiations between the main party and the partner parties (S404), the policy negotiation apparatus 100 checks whether all of the acceptance models have not changed (S406). If it is determined that all of the acceptance models have not changed (S406: NO), the negotiation apparatus 30 performs the next round of the negotiations in accordance with the current offer policy (S404).

On the other hand, if it is determined that one or more of the acceptance models have changed (S406: YES), the policy generation apparatus 100 performs the update of the offer policy and outputs the updated offer policy (S408). As a result, in the next round of the negotiations, the negotiation apparatus 30 performs the negotiations in accordance with the updated offer policy.

### Example of Functional Configuration

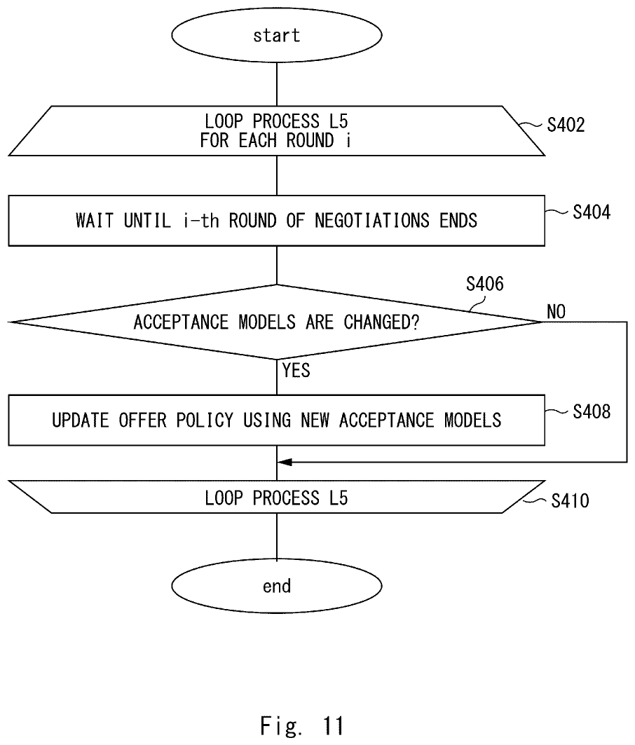

FIG. 11 shows a block diagram illustrating an example of the functional configuration of the policy generation apparatus 100 of the 2nd example embodiment. The policy generation apparatus 100 of the 2nd example embodiment further includes the detection unit 108. The detection unit 108 detects a fact that one or more of the acceptance models have changed.

### Example of Hardware Configuration

The hardware configuration of the policy generation apparatus 100 of the 2nd example embodiment may be the same as that of 1st example embodiment, except that the storage device 1080 further stores the programs with which the functions of the policy generation apparatus 100 is implemented.

<Detection of Change of Acceptance Model>

There are various ways by which the detection unit 108 detects a change in the acceptance model. For example, in a long negotiation, the detection unit 108 detects that the acceptance model has changed if the frequency of offers from the partner party deviates from the expectation given the acceptance model. As another example, if the acceptance model is based on environmental variables like the total demand in the market and the negotiation apparatus 30 has an external way to estimate this demand, a change in the demand entails a change in the acceptance model. A third possibility is to check the frequency of different values for specific negotiation issues (not complete offers) and compare them with the expectation from the acceptance model, and updating the acceptance model if they deviate from expectation by more than a predefined threshold.

<Update of Offer Policy>

After detecting a fact that one or more of the acceptance models have changed, the policy generation apparatus 100 updates the offer policy. For example, the policy generation apparatus 100 re-generates the offer policy from scratch through the processes shown in FIG. 5: the acquisition unit 102 acquires the new set of the acceptance models including the changed ones; the generation unit 104 generates the offer policy based on the new set of the acceptance models;

and the output unit 106 outputs the new offer policy in such a manner that the negotiation apparatus 30 can refer to the new offer policy from the next round. Note that it is not necessary for the acquisition unit 102 to acquire all of the acceptance models but only the acceptance models that has changed.

By the above method, it is possible to generate the new offer policy even in the case where all of the acceptance models have changed. However, in most cases, a few of the acceptance models change in a single round of the negotiations. Thus, it is highly possible to reuse some results of the past computations for generating the current offer policy to generate the new offer policy. The generation unit 104 may reuse such the results of the past computations, thereby generating the new offer policy more quickly.

Suppose that the acceptance model a\hat{ }d(ω\hat{ }d) for the main negotiator 32-d has changed for ω\hat{ }d in Θ, where Θ is a subset of Ω\hat{ }d. Note that Θ may include all of the outcomes in Ω\hat{ }d.

Under this assumption, the generation unit 104 may apply the following processes.

<<Evaluation of Equation (1): S206>>

At Step 206, the evaluations of p\hat{ }d(ω\hat{ }d|π\hat{ }d) change only for ω\hat{ }d being included in Θ. Thus, the generation unit 104 reevaluates p\hat{ }q(ω\hat{ }d|π\hat{ }d) for ω\hat{ }d being included in Θ. On the other hand, the generation unit 104 reuse the previous evaluation of p\hat{ }d(ω\hat{ }d|π\hat{ }d) forced not being included in Θ. In addition, the evaluations of p\hat{ }k(ω\hat{ }k|π\hat{ }k) does not change for k not being d. Thus, the generation unit 104 also reuses the previous evaluation of p\hat{ }k(ω\hat{ }k|πk) for k not being d.

<<Computation of Expected Utility: S212>>

In the case where the sampling method is used to compute the expected utility for the main negotiator 32-e, the expected utility under the changed acceptance models can be computed without resampling. Specifically, the generation unit 104 re-weight every sample using the reevaluated acceptance probability as follows:

$$\begin{matrix}Equation 9 & \\ E {U}^{e} ( {ω}^{e} = w \vert {π}^{e} ) = \frac{1}{S} {\sum }_{1 \leq r \leq S} \{ {\prod }_{1 \leq i \leq N} \frac{{q}^{í} ( {ω}_{r}^{i} \vert {π}^{í} )}{{p}^{i} ( {ω}_{r}^{i} \vert {π}^{i} )} u ( {ω}_{r}^{1} , … , {ω}_{r}^{N} ) \} & ( 9 )\end{matrix}$$

where qⁱ is the acceptance probability reevaluated with the changed acceptance models, ωᵣ^{e}=w ∀r, and
ωᵣⁱ represents the outcome sampled for the main negotiator 32-i at the r-th iteration of the loop process L4.

In order to handle the change of the acceptance model during the negotiations, it is preferable to speed up the computation of the offer policy. By removing the need for resampling as described above, a speedup of O(−ln(1-c)K\hat{ }2/ε\hat{ }2) is achieved. This means that the algorithm of computing the offer policy is linear in the outcome-space size.

Although the present disclosure is explained above with reference to example embodiments, the present disclosure is not limited to the above-described example embodiments. Various modifications that can be understood by those skilled in the art can be made to the configuration and details of the present disclosure within the scope of the invention.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The whole or part of the example embodiments disclosed above can be described as, but not limited to, the following supplementary notes.

### SUPPLEMENTARY NOTES

(Supplementary Note 1)

A policy generation apparatus comprising:

at least one processor and a memory storing instructions,

wherein the at least one processor is configured to execute the instructions to:
acquire an acceptance model for each of main negotiators, each of the main negotiators negotiating with different one of partner negotiators;
generates an offer policy using the obtained acceptance models, the offer policy including an offer sequence for each of the main negotiators, the offer sequence for the main negotiator including a sequence of offers which the corresponding main negotiator provides to the corresponding partner negotiator; and
output the generated offer policy,
the generation of the offer policy includes to initialize the offer policy and perform a modification of the offer policy,
the modification of the offer policy includes to perform, for each of the main negotiators:
computing a marginal distribution of a weighed global utility for that main negotiator, a distribution of the weighed global utility associating a set of outcomes each of which is obtained by the respective main negotiators with the weighed global utility given the set of the outcomes, the weighed global utility given the set of the outcomes being a global utility given the set of the outcomes weighed by probability of occurrence of the set of the outcomes that is computed using the acceptance models, the global utility representing criteria of quality of a whole of the negotiations between the main negotiators and the partner negotiators, the marginal distribution of the weighed global utility for that main negotiator being computed by marginalizing out the outcomes other than the outcome obtained by that main negotiator from the distribution of the weighed global utility; and
replacing the offer sequence of that main negotiator in the current offer policy by a new offer sequence of that main negotiator which maximizes an expected value of the global utility, the expected value of the global utility given the offer sequence being computed by summing the weighed global utilities each of which is associated with one of the offers in that offer sequence by the marginal distribution of the weighed global utility for that main negotiator.

(Supplementary Note 2)

The policy generation apparatus according to supplementary note 1,

wherein the at least one processor is further configured to repeatedly perform the modification of the offer policy until the offer policy is not changed by the modification of the offer policy.

(Supplementary Note 3)

The policy generation apparatus according to supplementary note 1 or 2, wherein the computation of the marginal distribution of the weighed global utility for a certain main negotiator includes to perform:
for each outcome from the certain main negotiator, sampling the outcome for each of the respective main negotiators other than the certain main negotiator and computing the weighed global utility given the outcome from the certain main negotiator and the sampled outcomes; and
handle a set of the weighed global utilities computed for each outcome from the certain main negotiator as the marginal distribution of the weighed global utility for the certain main negotiator.

(Supplementary Note 4)

The policy generation apparatus according to any one of supplementary notes 1 to 3,

wherein the at least one processor is further configured to:
detect a fact that one or more of the acceptance models have changed;
re-generate the offer policy based on the changed acceptance models;
output the re-generated offer policy.

(Supplementary Note 5)

The policy generation apparatus according to supplementary note 3,

wherein the at least one processor is further configured to:
detect a fact that one or more of the acceptance models have changed;
re-generate the offer policy based on the changed acceptance models;
output the re-generated offer policy,
the re-generation of the offer policy includes:
computing the weighed global utility given a set of the outcomes by multiplying a change ratio with the weighed global utility given that set of the outcomes under the acceptance models before changed, the change ratio being a ratio of probability of occurrence of that set of the outcomes under the changed acceptance models to probability of occurrence of that set of the outcomes under the acceptance models before changed.

(Supplementary Note 6)

The policy generation apparatus according to any one of supplementary notes 1 to 5,

wherein the replacement of the offer sequence of the main negotiator in the current offer policy includes to generate the new offer sequence of that main negotiator,

the generation of the new offer sequence of the main negotiator includes to: initialize a candidate location for each possible outcome of that main negotiator; and

repeatedly execute to:
perform a determination process in which an offer to be inserted into the new offer sequence and a location in the offer sequence at which the offer is to be inserted are determined; and
insert the determined offer into the determined location of the new offers sequence,

the determination process includes to:
for each possible outcome, calculate the expected utility given the new offer policy under an assumption of that outcome being inserted at the candidate location of that outcome in the new offer policy;
determine the outcome with which the expected utility is maximized as the outcome to be inserted into the new offer policy, and determine the candidate location of the determined outcome as the location in the offer sequence at which the determined outcome is to be inserted; and
   increment the candidate location for each outcome with the expected utility less than the expected utility calculated for the determined outcome.

(Supplementary Note 7)

A control method performed by a computer, comprising:
acquiring an acceptance model for each of main negotiators, each of the main negotiators negotiating with different one of partner negotiators;
generating an offer policy using the obtained acceptance models, the offer policy including an offer sequence for each of the main negotiators, the offer sequence for the main negotiator including a sequence of offers which the corresponding main negotiator provides to the corresponding partner negotiator; and
outputting the generated offer policy,
the generation of the offer policy includes to initialize the offer policy and perform a modification of the offer policy,
the modification of the offer policy includes to perform, for each of the main negotiators:
computing a marginal distribution of a weighed global utility for that main negotiator, a distribution of the weighed global utility associating a set of outcomes each of which is obtained by the respective main negotiators with the weighed global utility given the set of the outcomes, the weighed global utility given the set of the outcomes being a global utility given the set of the outcomes weighed by probability of occurrence of the set of the outcomes that is computed using the acceptance models, the global utility representing criteria of quality of a whole of the negotiations between the main negotiators and the partner negotiators, the marginal distribution of the weighed global utility for that main negotiator being computed by marginalizing out the outcomes other than the outcome obtained by that main negotiator from the distribution of the weighed global utility; and
replacing the offer sequence of that main negotiator in the current offer policy by the offer sequence of that main negotiator which maximizes an expected value of the global utility, the expected value of the global utility given the offer sequence being computed by summing the weighed global utilities each of which is associated with one of the offers in that offer sequence by the marginal distribution of the weighed global utility for that main negotiator.

(Supplementary Note 8)

The control method according to supplementary note 7,

wherein the modification of the offer policy is performed repeatedly until the offer policy is not changed by the modification of the offer policy.

(Supplementary Note 9)

The control method according to supplementary note 7 or 8

wherein the computation of the marginal distribution of the weighed global utility for a certain main negotiator includes to perform:
for each outcome from the certain main negotiator, sampling the outcome for each of the respective main negotiators other than the certain main negotiator and computing the weighed global utility given the outcome from the certain main negotiator and the sampled outcomes; and
handle a set of the weighed global utilities computed for each outcome from the certain main negotiator as the marginal distribution of the weighed global utility for the certain main negotiator.

(Supplementary Note 10)

The control method according to any one of supplementary notes 7 to 9, further comprising:
detecting a fact that one or more of the acceptance models have changed; re-generating the offer policy based on the changed acceptance models; outputting the re-generated offer policy.

(Supplementary Note 11)

The control method according to supplementary note 9, further comprising:
detecting a fact that one or more of the acceptance models have changed;
re-generating the offer policy based on the changed acceptance models; outputting the re-generated offer policy,
the re-generation of the offer policy includes:
computing the weighed global utility given a set of the outcomes by multiplying a change ratio with the weighed global utility given that set of the outcomes under the acceptance models before changed, the change ratio being a ratio of probability of occurrence of that set of the outcomes under the changed acceptance models to probability of occurrence of that set of the outcomes under the acceptance models before changed.

(Supplementary Note 12)

The control method according to any one of supplementary notes 7 to 11,

wherein the replacement of the offer sequence of the main negotiator in the current offer policy includes to generate the new offer sequence of that main negotiator,

the generation of the new offer sequence of the main negotiator includes to:

initialize a candidate location for each possible outcome of that main negotiator; and

repeatedly execute to:
perform a determination process in which an offer to be inserted into the new offer sequence and a location in the offer sequence at which the offer is to be inserted are determined; and
insert the determined offer into the determined location of the new offers sequence,

the determination process includes to:
for each possible outcome, calculate the expected utility given the new offer policy under an assumption of that outcome being inserted at the candidate location of that outcome in the new offer policy;
determine the outcome with which the expected utility is maximized as the outcome to be inserted into the new offer policy, and determine the candidate location of the determined outcome as the location in the offer sequence at which the determined outcome is to be inserted; and
increment the candidate location for each outcome with the expected utility less than the expected utility calculated for the determined outcome.

(Supplementary Note 13)

A non-transitory computer-readable storage medium storing a program that causes a computer to perform:
acquiring an acceptance model for each of main negotiators, each of the main negotiators negotiating with different one of partner negotiators;
generating an offer policy using the obtained acceptance models, the offer policy including an offer sequence for each of the main negotiators, the offer sequence for the main negotiator including a sequence of offers which the corresponding main negotiator provides to the corresponding partner negotiator; and
outputting the generated offer policy,
the generation of the offer policy includes to initialize the offer policy and perform a modification of the offer policy,
the modification of the offer policy includes to perform, for each of the main negotiators:
computing a marginal distribution of a weighed global utility for that main negotiator, a distribution of the weighed global utility associating a set of outcomes each of which is obtained by the respective main negotiators with the weighed global utility given the set of the outcomes, the weighed global utility given the set of the outcomes being a global utility given the set of the outcomes weighed by probability of occurrence of the set of the outcomes that is computed using the acceptance models, the global utility representing criteria of quality of a whole of the negotiations between the main negotiators and the partner negotiators, the marginal distribution of the weighed global utility for that main negotiator being computed by marginalizing out the outcomes other than the outcome obtained by that main negotiator from the distribution of the weighed global utility; and
replacing the offer sequence of that main negotiator in the current offer policy by the offer sequence of that main negotiator which maximizes an expected value of the global utility, the expected value of the global utility given the offer sequence being computed by summing the weighed global utilities each of which is associated with one of the offers in that offer sequence by the marginal distribution of the weighed global utility for that main negotiator.

(Supplementary Note 14)

The storage medium according to supplementary note 13,

wherein the modification of the offer policy is performed repeatedly until the offer policy is not changed by the modification of the offer policy.

(Supplementary Note 15)

The storage medium according to supplementary note 13 or 14

wherein the computation of the marginal distribution of the weighed global utility for a certain main negotiator includes to perform:
for each outcome from the certain main negotiator, sampling the outcome for each of the respective main negotiators other than the certain main negotiator and computing the weighed global utility given the outcome from the certain main negotiator and the sampled outcomes; and
handle a set of the weighed global utilities computed for each outcome from the certain main negotiator as the marginal distribution of the weighed global utility for the certain main negotiator.

(Supplementary Note 16)

The storage medium according to any one of supplementary notes 13 to 15,

wherein the program causes the computer further execute:
detecting a fact that one or more of the acceptance models have changed;
re-generating the offer policy based on the changed acceptance models;
outputting the re-generated offer policy.

(Supplementary Note 17)

The storage medium according to supplementary note 15,

wherein the program causes the computer further execute:
detecting a fact that one or more of the acceptance models have changed;
re-generating the offer policy based on the changed acceptance models;
outputting the re-generated offer policy,
the re-generation of the offer policy includes:
computing the weighed global utility given a set of the outcomes by multiplying a change ratio with the weighed global utility given that set of the outcomes under the acceptance models before changed, the change ratio being a ratio of probability of occurrence of that set of the outcomes under the changed acceptance models to probability of occurrence of that set of the outcomes under the acceptance models before changed.

(Supplementary Note 18)

The storage medium according to any one of supplementary notes 13 to 17,

wherein the replacement of the offer sequence of the main negotiator in the current offer policy includes to generate the new offer sequence of that main negotiator,

the generation of the new offer sequence of the main negotiator includes to:

initialize a candidate location for each possible outcome of that main negotiator; and

repeatedly execute to:
perform a determination process in which an offer to be inserted into the new offer sequence and a location in the offer sequence at which the offer is to be inserted are determined; and
insert the determined offer into the determined location of the new offers sequence,
the determination process includes to:
   for each possible outcome, calculate the expected utility given the new offer policy under an assumption of that outcome being inserted at the candidate location of that outcome in the new offer policy;
   determine the outcome with which the expected utility is maximized as the outcome to be inserted into the new offer policy, and determine the candidate location of the determined outcome as the location in the offer sequence at which the determined outcome is to be inserted; and
   increment the candidate location for each outcome with the expected utility less than the expected utility calculated for the determined outcome.

### REFERENCE SIGNS LIST

10 main party
20 partner party
30 negotiation apparatus
32 main negotiator
40 negotiation apparatus
42 partner negotiator
100 policy generation apparatus
102 acquisition unit
104 generation unit
106 output unit
108 detection unit
200 table
210 negotiation subject
212 partner party
214 product
220 acceptance model
1000 computer
1020 bus
1040 processor
1060 memory
1080 storage device
1100 input/output interface
1120 network interface

1. A policy generation apparatus comprising:
at least one processor and a memory storing instructions,
wherein the at least one processor is configured to execute the instructions to:
acquire an acceptance model for each of main negotiators, each of the main negotiators negotiating with different one of partner negotiators;
generates an offer policy using the obtained acceptance models, the offer policy including an offer sequence for each of the main negotiators, the offer sequence for the main negotiator including a sequence of offers which the corresponding main negotiator provides to the corresponding partner negotiator; and
output the generated offer policy,
wherein the generation of the offer policy includes to initialize the offer policy and perform a modification of the offer policy, and
wherein the modification of the offer policy includes to perform, for each of the main negotiators:
computing a marginal distribution of a weighed global utility for that main negotiator, a distribution of the weighed global utility associating a set of outcomes each of which is obtained by the respective main negotiators with the weighed global utility given the set of the outcomes, the weighed global utility given the set of the outcomes being a global utility given the set of the outcomes weighed by probability of occurrence of the set of the outcomes that is computed using the acceptance models, the global utility representing criteria of quality of a whole of the negotiations between the main negotiators and the partner negotiators, the marginal distribution of the weighed global utility for that main negotiator being computed by marginalizing out the outcomes other than the outcome obtained by that main negotiator from the distribution of the weighed global utility; and
replacing the offer sequence of that main negotiator in a current offer policy by a new offer sequence of that main negotiator which maximizes an expected value of the global utility, the expected value of the global utility given the offer sequence being computed by summing the weighed global utilities each of which is associated with one of the offers in that offer sequence by the marginal distribution of the weighed global utility for that main negotiator.

2. The policy generation apparatus according to claim 1,
wherein the at least one processor is further configured to repeatedly perform the modification of the offer policy until the offer policy is not changed by the modification of the offer policy.

3. The policy generation apparatus according to claim 1,
wherein the computation of the marginal distribution of the weighed global utility for a certain main negotiator includes to perform:
for each outcome from the certain main negotiator, sampling the outcome for each of the respective main negotiators other than the certain main negotiator and computing the weighed global utility given the outcome from the certain main negotiator and the sampled outcomes; and
handling a set of the weighed global utilities computed for each outcome from the certain main negotiator as the marginal distribution of the weighed global utility for the certain main negotiator.

4. The policy generation apparatus according to claim 1,
wherein the at least one processor is further configured to:
detect a fact that one or more of the acceptance models have changed;
re-generate the offer policy based on the changed acceptance models; and
output the re-generated offer policy.

5. The policy generation apparatus according to claim 3,
wherein the at least one processor is further configured to:
detect a fact that one or more of the acceptance models have changed;
re-generate the offer policy based on the changed acceptance models; and
output the re-generated offer policy, and
wherein the re-generation of the offer policy includes: computing the weighed global utility given a set of the outcomes by multiplying a change ratio with the weighed global utility given that set of the outcomes under the acceptance models before changed, the change ratio being a ratio of probability of occurrence of that set of the outcomes under the changed acceptance models to probability of occurrence of that set of the outcomes under the acceptance models before changed.

6. The policy generation apparatus according to claim 1,
wherein the replacement of the offer sequence of the main negotiator in the current offer policy includes to generate the new offer sequence of that main negotiator,
wherein the generation of the new offer sequence of the main negotiator includes to:
initialize a candidate location for each possible outcome of that main negotiator; and
repeatedly execute to:
perform a determination process in which an offer to be inserted into the new offer sequence and a location in the offer sequence at which the offer is to be inserted are determined; and
insert the determined offer into the determined location of the new offers sequence, and
wherein the determination process includes to:
for each possible outcome, calculate the expected utility given the new offer policy under an assumption of that outcome being inserted at the candidate location of that outcome in the new offer policy;
determine the outcome with which the expected utility is maximized as the outcome to be inserted into the new offer policy, and determine the candidate location of the determined outcome as the location in the offer sequence at which the determined outcome is to be inserted; and
increment the candidate location for each outcome with the expected utility less than the expected utility calculated for the determined outcome.

7. A control method performed by a computer, comprising:
acquiring an acceptance model for each of main negotiators, each of the main negotiators negotiating with different one of partner negotiators;
generating an offer policy using the obtained acceptance models, the offer policy including an offer sequence for each of the main negotiators, the offer sequence for the main negotiator including a sequence of offers which the corresponding main negotiator provides to the corresponding partner negotiator; and
outputting the generated offer policy,
wherein the generation of the offer policy includes to initialize the offer policy and perform a modification of the offer policy, and
wherein the modification of the offer policy includes to perform, for each of the main negotiators:
computing a marginal distribution of a weighed global utility for that main negotiator, a distribution of the weighed global utility associating a set of outcomes each of which is obtained by the respective main negotiators with the weighed global utility given the set of the outcomes, the weighed global utility given the set of the outcomes being a global utility given the set of the outcomes weighed by probability of occurrence of the set of the outcomes that is computed using the acceptance models, the global utility representing criteria of quality of a whole of the negotiations between the main negotiators and the partner negotiators, the marginal distribution of the weighed global utility for that main negotiator being computed by marginalizing out the outcomes other than the outcome obtained by that main negotiator from the distribution of the weighed global utility; and
replacing the offer sequence of that main negotiator in a current offer policy by the offer sequence of that main negotiator which maximizes an expected value of the global utility, the expected value of the global utility given the offer sequence being computed by summing the weighed global utilities each of which is associated with one of the offers in that offer sequence by the marginal distribution of the weighed global utility for that main negotiator.

8. The control method according to claim 7,
wherein the modification of the offer policy is performed repeatedly until the offer policy is not changed by the modification of the offer policy.

9. The control method according to claim 7,
wherein the computation of the marginal distribution of the weighed global utility for a certain main negotiator includes to perform:
for each outcome from the certain main negotiator, sampling the outcome for each of the respective main negotiators other than the certain main negotiator and computing the weighed global utility given the outcome from the certain main negotiator and the sampled outcomes; and
handling a set of the weighed global utilities computed for each outcome from the certain main negotiator as the marginal distribution of the weighed global utility for the certain main negotiator.

10. The control method according to claim 7, further comprising:
detecting a fact that one or more of the acceptance models have changed;
re-generating the offer policy based on the changed acceptance models; and
outputting the re-generated offer policy.

11. The control method according to claim 9, further comprising:
detecting a fact that one or more of the acceptance models have changed;
re-generating the offer policy based on the changed acceptance models; and
outputting the re-generated offer policy,
wherein the re-generation of the offer policy includes: computing the weighed global utility given a set of the outcomes by multiplying a change ratio with the weighed global utility given that set of the outcomes under the acceptance models before changed, the change ratio being a ratio of probability of occurrence of that set of the outcomes under the changed acceptance models to probability of occurrence of that set of the outcomes under the acceptance models before changed.

12. The control method according to claim 7,
wherein the replacement of the offer sequence of the main negotiator in the current offer policy includes to generate the new offer sequence of that main negotiator,
wherein the generation of the new offer sequence of the main negotiator includes to:
initialize a candidate location for each possible outcome of that main negotiator; and
repeatedly execute to:
perform a determination process in which an offer to be inserted into the new offer sequence and a location in the offer sequence at which the offer is to be inserted are determined; and
insert the determined offer into the determined location of the new offers sequence, and
wherein the determination process includes to:
for each possible outcome, calculate the expected utility given the new offer policy under an assumption of that outcome being inserted at the candidate location of that outcome in the new offer policy;
determine the outcome with which the expected utility is maximized as the outcome to be inserted into the new offer policy, and determine the candidate location of the determined outcome as the location in the offer sequence at which the determined outcome is to be inserted; and
increment the candidate location for each outcome with the expected utility less than the expected utility calculated for the determined outcome.

13. A non-transitory computer-readable storage medium storing a program that causes a computer to perform:
acquiring an acceptance model for each of main negotiators, each of the main negotiators negotiating with different one of partner negotiators;
generating an offer policy using the obtained acceptance models, the offer policy including an offer sequence for each of the main negotiators, the offer sequence for the main negotiator including a sequence of offers which the corresponding main negotiator provides to the corresponding partner negotiator; and
outputting the generated offer policy,
wherein the generation of the offer policy includes to initialize the offer policy and perform a modification of the offer policy, and
wherein the modification of the offer policy includes to perform, for each of the main negotiators:
computing a marginal distribution of a weighed global utility for that main negotiator, a distribution of the weighed global utility associating a set of outcomes each of which is obtained by the respective main negotiators with the weighed global utility given the set of the outcomes, the weighed global utility given the set of the outcomes being a global utility given the set of the outcomes weighed by probability of occurrence of the set of the outcomes that is computed using the acceptance models, the global utility representing criteria of quality of a whole of the negotiations between the main negotiators and the partner negotiators, the marginal distribution of the weighed global utility for that main negotiator being computed by marginalizing out the outcomes other than the outcome obtained by that main negotiator from the distribution of the weighed global utility; and
replacing the offer sequence of that main negotiator in a current offer policy by the offer sequence of that main negotiator which maximizes an expected value of the global utility, the expected value of the global utility given the offer sequence being computed by summing the weighed global utilities each of which is associated with one of the offers in that offer sequence by the marginal distribution of the weighed global utility for that main negotiator.

14. The storage medium according to claim 13,
wherein the modification of the offer policy is performed repeatedly until the offer policy is not changed by the modification of the offer policy.

15. The storage medium according to claim 13,
wherein the computation of the marginal distribution of the weighed global utility for a certain main negotiator includes to perform:
for each outcome from the certain main negotiator, sampling the outcome for each of the respective main negotiators other than the certain main negotiator and computing the weighed global utility given the outcome from the certain main negotiator and the sampled outcomes; and
handling a set of the weighed global utilities computed for each outcome from the certain main negotiator as the marginal distribution of the weighed global utility for the certain main negotiator.

16. The storage medium according to claim 13,
wherein the program causes the computer further execute:
detecting a fact that one or more of the acceptance models have changed;
re-generating the offer policy based on the changed acceptance models; and
outputting the re-generated offer policy.

17. The storage medium according to claim 15,
wherein the program causes the computer further execute:
detecting a fact that one or more of the acceptance models have changed;
re-generating the offer policy based on the changed acceptance models; and
outputting the re-generated offer policy, and
wherein the re-generation of the offer policy includes: computing the weighed global utility given a set of the outcomes by multiplying a change ratio with the weighed global utility given that set of the outcomes under the acceptance models before changed, the change ratio being a ratio of probability of occurrence of that set of the outcomes under the changed acceptance models to probability of occurrence of that set of the outcomes under the acceptance models before changed.

18. The storage medium according to claim 13,
wherein the replacement of the offer sequence of the main negotiator in the current offer policy includes to generate the new offer sequence of that main negotiator,
wherein the generation of the new offer sequence of the main negotiator includes to:
initialize a candidate location for each possible outcome of that main negotiator; and
repeatedly execute to:
perform a determination process in which an offer to be inserted into the new offer sequence and a location in the offer sequence at which the offer is to be inserted are determined; and
insert the determined offer into the determined location of the new offers sequence, and
wherein the determination process includes to:
for each possible outcome, calculate the expected utility given the new offer policy under an assumption of that outcome being inserted at the candidate location of that outcome in the new offer policy;
determine the outcome with which the expected utility is maximized as the outcome to be inserted into the new offer policy, and determine the candidate location of the determined outcome as the location in the offer sequence at which the determined outcome is to be inserted; and
increment the candidate location for each outcome with the expected utility less than the expected utility calculated for the determined outcome.
